(19) United States
(12) Patent Application Publication
(10) Pub. No.: US 2022/0278641 A1
(43) Pub. Date: Sep. 1, 2022

(54) Tie Rod for a Structure, in Particular a Lattice Structure

(71) Applicant: NEXANS, Courbevoie (FR)

(72) Inventors: Jérome TORDO, Aix-En-Provence (FR); Fabien VIENNOIS, MESSERY (FR)

(21) Appl. No.: 17/625,658

(22) PCT Filed: Jun. 16, 2020
(86) PCT No.: PCT/FR2020/051036

§ 371 Date: Jan. 7, 2022

(30) Foreign Application Priority Data
Jul. 15, 2019 (FR) FR19 07919

(51) Int. Cl. H02S 20/32; E04C 3/08; G05D 3/10

(52) U.S. Cl. CPC H02S 20/32; E04C 3/08; G05D 3/105; E04C 2003/0413

(57) ABSTRACT

The present invention relates to a tie rod (13) capable of being fastened at two fastening points of a structure, said tie rod (13) having a first fastening end (15) comprising a first circular opening (17), and a second fastening end (16) comprising a second circular opening (18). According to the invention, the tie rod (13) has a washer (19) which is provided with an off-centre orifice (21), said washer (19) being received concentrically in the second circular opening (18) and being movable in rotation in said second circular opening (18) so as to modify the position of the off-centre orifice (21) in order to vary an interaxial fastening distance between said off-centre orifice (21) and the first circular opening (17).

### TECHNICAL FIELD

The present invention relates to the fastening of rigid tie rods on structures.

In particular, the invention relates to a tie rod capable of being fastened at two fastening points of a structure, the tie rod having two fastening ends, each of which comprises a circular fastening opening.

Such a tie rod is conventionally fastened to the structure by placing each circular fastening opening in front of a corresponding opening at the point of fastening on the structure and by assembling each fastening end using a bolt system, the fastening screw of which passes through the openings placed next to one another.

### TECHNOLOGICAL BACKGROUND

In many structures, in particular metal lattice structures, tie rods are used in order to rigidify the whole.

Such a use of tie rods is made in a lattice structure which is described in document WO 2018/033495 in the name of the Applicant, the lattice structure being used as a supporting structure for a table of a solar tracker.

However, the constituent elements of the structure on which the tie rods are fastened are manufactured with manufacturing tolerances, thus making the distance between the points of fastening of the tie rods on the structure vary substantially.

Compensation for these tolerance differences cannot be carried out by introducing play at the fastening points, the risk of buckling of the tie rods becoming high under these circumstances. In order to avoid buckling of the tie rods, they should preferably be fastened with a slight tensile pretension.

Currently, this problem is resolved with a thread/nut system at the tip of the tie rod. However, this solution proves expensive and requires significant mounting time.

### SUMMARY OF THE INVENTION

The present invention describes a tie rod, of which the elements allowing it to be fastened on a structure make it possible to respond to the problems of tolerance and pretension mentioned above, while offering a low manufacturing cost and a reduced mounting time.

More particularly, the present invention firstly relates to a tie rod capable of being fastened at two fastening points of a structure by means of two fastening screws, said tie rod having a longitudinal body provided with a first fastening end comprising a first circular opening, and a second fastening end comprising a second circular opening, characterized in that it has a washer which comprises a cylindrical external envelope body and is provided with an off-centre through-orifice, said washer being received concentrically in the second circular opening and being movable in rotation in said second circular opening so as to modify the position of the off-centre orifice in order to vary an interaxial fastening distance between said off-centre orifice and the first circular opening.

According to other advantageous and nonlimiting characteristics of the tie rod according to the invention:

said cylindrical external envelope body may be extended by a bearing collar, an inner bearing surface of which is adapted to come to bear against a planar surface of the second fastening end of the tie rod;

said bearing collar may form a polygonal head of the washer;

the inner bearing surface of said bearing collar preferably has a zone which is structured so as to increase the coefficient of friction of the contact between said inner bearing surface and the planar surface of the second fastening end of the tie rod;

said structured zone is formed, for example, by spikes protruding in the axial direction of the washer or by strips arranged radially around the axis of the washer;

as a variant, the inner bearing surface of said bearing collar may have a coating made of a material of the adhesive type so as to increase the coefficient of friction of the contact between said inner bearing surface and the planar surface of the second fastening end of the tie rod;

the second circular opening has a diameter greater than the diameter of the first circular opening;

the off-centre orifice has a diameter substantially equal to the diameter of the first circular opening.

The invention also relates to a method for mounting the above tie rod on a structure, characterized in that it comprises:

a step of fastening the first fastening end of the tie rod at a first fastening point of the structure, by means of a first fastening screw passing through the first circular opening of the tie rod and a first opening of the structure, which is next to said first circular opening;

a step of positioning the second fastening end of the tie rod substantially next to a second opening, which is located at a second fastening point of the structure, by pivoting the tie rod about the axis of the first fastening screw;

a step of adjusting the position of the off-centre orifice of the washer by rotating the washer in the second circular opening and pivoting the tie rod about the axis of the first fastening screw, in order to position the off-centre orifice in front of the second opening;

a step of fastening the second fastening end of the tie rod to said second fastening point of the structure, by means of a second fastening screw passing through the off-centre orifice of the washer and said second opening.

According to other advantageous and nonlimiting characteristics of the method according to the invention:

the second fastening screw is preferably tightened with a tightening torque sufficient to oppose rotation of the washer if the tie rod is subjected to a longitudinal tensile force;

prior to the tightening, a torque may be applied to the washer in order to put a slight tension into the tie rod.

The invention furthermore relates to a lattice structure having rails extending mutually parallel along a main extent direction, crossbeams distributed along the main extent direction in order to mechanically connect the rails in pairs, and a plurality of tie rods which connect two adjacent rails and two consecutive crossbeams, said lattice structure being characterized in that at least one tie rod of the plurality of tie rods is a tie rod according to the first subject of the invention.

The invention furthermore relates to a solar tracker, comprising:

a mobile device comprising a table equipped with at least one solar energy collection device, a supporting structure extending longitudinally over a length L in order to support said table, a first supporting arch and a second supporting arch, which are configured to support said supporting structure;

a first ground bearing support and a second ground bearing support, which are configured respectively to support the first supporting arch and the second supporting arch; and

a kinematic drive device configured to drive the mobile device in rotation relative to the first ground bearing support and the second ground bearing support;

the solar tracker being characterized in that said supporting structure is a lattice structure according to the invention.

### BRIEF DESCRIPTION OF THE FIGURES

The description which follows with reference to the appended drawings, which are given by way of nonlimiting examples, will clearly explain what the invention consists in and how it may be carried out. In the appended figures:

FIG. 1 illustrates certain elements of a mobile device of a solar tracker, showing in particular a known lattice supporting structure;

FIG. 2 partially illustrates a side view of the lattice supporting structure of FIG. 1;

FIG. 3 illustrates three views (a) (b) and (c) of a tie rod according to one possible embodiment of the invention, respectively without the fastening washer and with the fastening washer having an off-centre orifice, according to two different positions of the washer;

FIG. 4 illustrates a three-quarter view (a) and a view from below (b) of one possible embodiment of a fastening washer with an off-centre orifice, with which the tie rod of FIG. 3 is equipped, according to the invention;

FIG. 5 illustrates various steps of a method for mounting a tie rod at two points of a structure according to the invention;

FIG. 6 is a side view of one end of the tie rod once assembled with the structure.

### DESCRIPTION OF EMBODIMENT(S)

In the appended figures, elements which are the same or equivalent will have the same references.

In what follows, the invention will be described in the nonlimiting context of using tie rods for lattice structures used in solar trackers. The principle, which will be described in detail below, of the adjustable fastening of a tie rod may of course be applied to any structure having at least one tie rod fastened at its two ends to the structure.

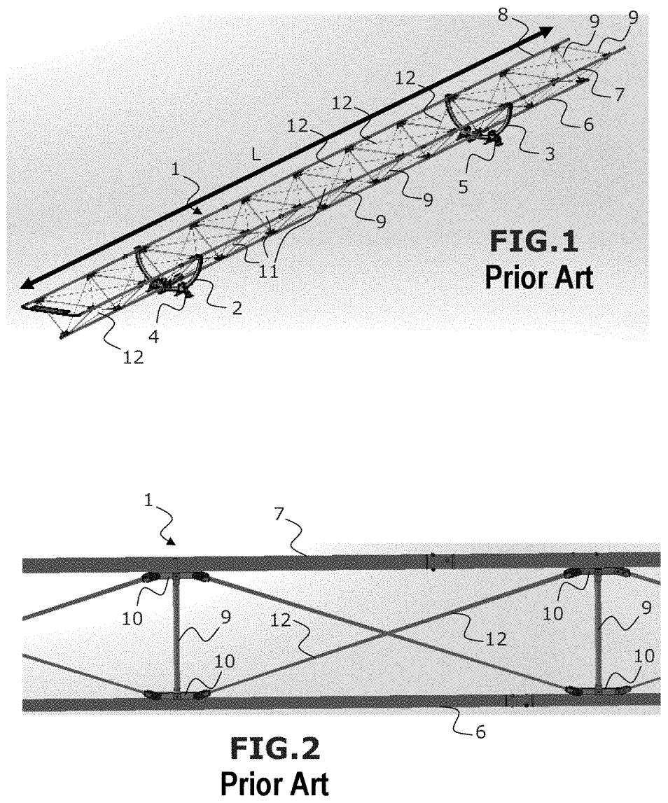

FIGS. 1 and 2 represent certain components of a solar tracker which is known, in particular, from document WO 2018/033495. This solar tracker essentially comprises:

a mobile device comprising a table (not represented) equipped with at least one solar energy collection device, for example a photovoltaic panel, a supporting structure 1 which extends longitudinally over a length L in order to support the table, a first supporting arch 2 and a second supporting arch 3, which are configured to support the supporting structure 1;

a first ground bearing support 4 and a second ground bearing support 5, which are configured respectively to support the first supporting arch 2 and the second supporting arch 3.

In the nonlimiting embodiment represented, the first supporting arch 2 and the second supporting arch 3 are arranged at a certain distance from the ends of the supporting structure 1. The supporting structure 1 is thus arranged overhanging on the first ground bearing support 4 via the first supporting arch 2 and on the second ground bearing support 5 via the second supporting arch 3, which allows advantageous distribution of the mechanical stresses supported by the supporting structure 1, making it possible to reduce the weight and the deformations (deflection) of the mobile device while maintaining a high mechanical strength.

The supporting structure 1 is a lattice structure having rails extending mutually parallel along a main extent direction and crossbeams distributed along the main extent direction in order to mechanically connect the rails in pairs.

In the nonlimiting example represented in FIGS. 1 and 2, the lattice structure has three rails 6, 7 and 8, which extend mutually parallel along the main extent direction, as well as a large number of crossbeams.

Each of the two ends of each crossbeam 9 is connected to one of the three rails 6, 7 or 8 by means of a plate 10 fastened to this rail.

As may be seen more particularly in FIG. 1, the crossbeams 9 may be arranged relative to the three rails 6, 7 and 8 so as to form a plurality of mutually parallel triangles 11, each contained in a plane perpendicular to the main extent direction. The triangles may be distributed regularly along the main extent direction. As a variant, the density of the triangles may be increased locally in the zones of the structure for which it is desired to increase the mechanical strength, for example at one and/or other of the first and second supporting arches 2 and 3.

The supporting structure 1 also comprises tie rods 12. These tie rods 12 are arranged so as to connect two triangles 11 in pairs. For example, as may be seen in FIG. 2, two tie rods 12 connect two consecutive triangles by their ends connected on the one hand, for each tie rod 12, at one corresponding plate 10 fastened to the rail 7, and on the other hand at another corresponding plate 10 fastened to the rail 6. The tie rods 12 may advantageously be stressed in tension so as to increase the mechanical strength of the supporting structure 1. As may be seen in FIG. 1, the structure may have a large number of tie rods 12, each tie rod connecting two vertices of two consecutive triangles 11.

As indicated in the introduction, one problem frequently encountered during the mounting of structures such as are presented above is the variation of the dimensions of the different structural elements. Specifically, these variations, which are due to manufacturing tolerances, usually need to be compensated for with play at the fastenings. A tie rod, at least one fastening end of which carries an off-centre washer according to the invention, makes it possible to respond to this problem by allowing adjustment of the distance between the fastening points on the tie rod, thus proposing control without play despite the dimensional variations of the structural elements.

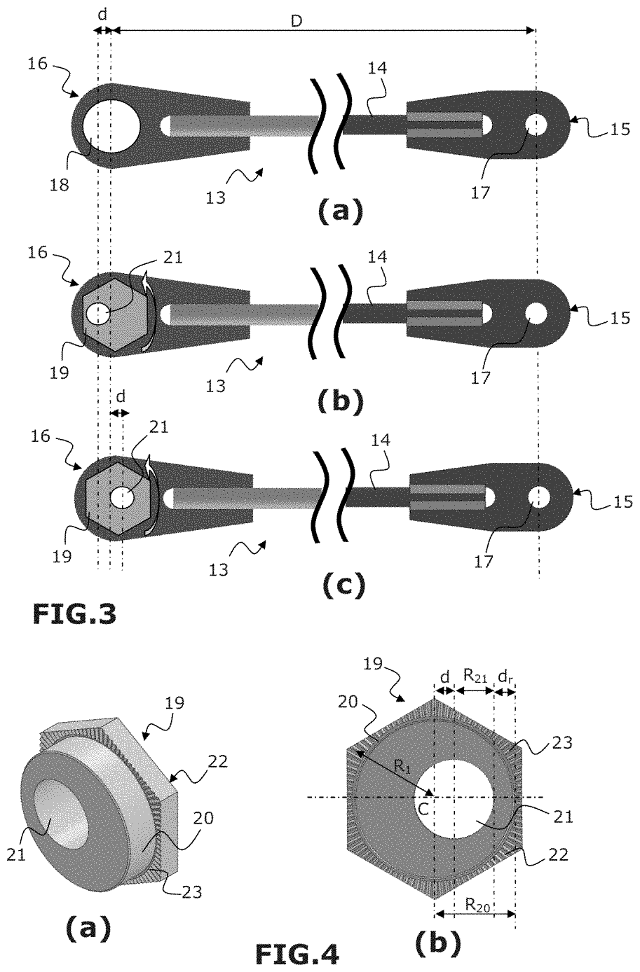

FIG. 3 represents a tie rod 13 according to one possible embodiment of the invention. This tie rod may in particular be used instead of any of the tie rods 12 of the lattice structure 1 of FIGS. 1 and 2, which were described above. FIG. 3 more precisely illustrates a first view (a) corresponding to the tie rod without the off-centre washer, a second view (b) corresponding to the tie rod with the off-centre washer in a first angular position, and a third view (c) corresponding to the tie rod with the off-centre washer in a second angular position 180 degrees opposite relative to the first angular position.

The tie rod 13 comprises a longitudinal body 14, for example a metal body with a circular cross section, provided with two fastening ends 15 and 16 allowing the tie rod to be fastened at two fastening points of a structure.

Each fastening end 15, 16 conventionally comprises a circular opening, 17 and 18 respectively. In the nonlimiting example represented in the figures, each fastening end 15, 16 is formed by a flattened adapter, which is fastened to one end of the longitudinal body 14 of the tie rod 13 and is pierced with the corresponding circular through-opening 17 or 18. The fastening of the adapter may be carried out in any possible way, in particular by welding or soldering. As an alternative, the adapters may be integrated with the body 14 of the tie rod 13. The flattened adapters forming the two fastening ends 15, 16 extend in the same plane and are pierced in order to form the circular through-openings 17 and 18.

The diameter of the circular opening 17 is selected so as to be able to axially receive an assembling member, for example, conventionally, the screw stem of a bolt.

The diameter of the circular opening 18 is greater than the diameter of the circular opening 17, so as to be able to accommodate an off-centre washer 19 concentrically, as will be explained below.

In a conventional tie rod, the distance D separating the centres of the circular through-openings 17 and 18 fixes the value of the interaxial fastening distance of the tie rod.

In a different way, and according to the invention, the interaxial fastening distance of the tie rod 13 is made adjustable by virtue of the use of a particular washer 19 which is received concentrically in the circular through-opening 18 (FIG. 3 (b)).

FIG. 4 represents two views of an exemplary embodiment of such a washer 19, namely a three-quarter view (a) and a view from below (b). The washer is represented on its own, before mounting in the circular opening 18 of the fastening end 16 of the tie rod of FIG. 3(a).

The washer 19 is formed by a cylindrical external envelope body 20 which is pierced with a circular through-orifice 21 having a radius R₂₁. Preferably, the through-orifice 21 has the same diameter as the circular opening 17 provided on the other end 15 of the tie rod, this diameter needing to be sufficient to receive a fastening screw axially. This advantageously makes it possible to use the same fastening screws for each of the two ends of the tie rod. This diameter is preferably slightly greater than the outer diameter of the fastening screw (according to the dimensionings known in the art), this being in order to ensure fastening without play. The radius R₂₀ of the cylindrical external envelope 20 is preferably determined by the following relationship:

R₂₀=d+R₂₁+dᵣ [Math. 1]

where dᵣ corresponds to a sufficient material margin which ensures mechanical durability of said off-centre washer.

As may more particularly be seen, particularly in FIG. 3(b) and FIG. 4(b), the through-orifice 21 is off-centre by a distance d relative to the centre C of the cylindrical external envelope 20, in contrast to a conventional washer whose orifice is central. The distance d is for example equal to 4 millimetres. The cylindrical external envelope body 20 has a height sufficient to make it possible to hold the washer 19 in the circular opening 18, this height preferably being at most equal to the thickness of the flattened adapter forming the fastening end 16 of the tie rod 13.

The cylindrical envelope body 20 of the washer 19 is extended axially by a bearing collar 22. The off-centre orifice 21 also passes axially through the bearing collar 22.

That surface of the collar 22 which is oriented in front of the cylindrical envelope body 20 forms an inner bearing surface 23 of the washer 19, which is adapted to come to bear against the planar surface of the flattened adapter on the second fastening end 16 of the tie rod 13 when the washer 19 is received in the circular opening 18. The inner bearing surface 23 preferably has a zone which is structured so as to increase the coefficient of friction of the contact between the inner bearing surface and the planar surface of the second fastening end 16 of the tie rod, for reasons which will be explained below. This structured zone may be produced by removing material or by adding material. Preferably, as illustrated in the figures, the textured zone is formed by strips arranged on the inner bearing surface 23, radially around the axis of the washer 19, increasing in particular the coefficient of friction in the tangential direction. As an alternative, the textured zone may be formed by spikes protruding in the axial direction of the washer 9, which are arranged uniformly or in groups on the inner bearing surface 23. Thus, it is also possible to form radial strips with the aid of protruding spikes. Instead of or in addition to a structured zone, it is also possible to increase the coefficient of friction by adding an additional material of the adhesive type, for example as a coating on the inner bearing surface 23.

The bearing collar 22 may be polygonally shaped in order to simplify handling of the washer with the aid of a tool. Preferably, the bearing collar 22 is hexagonal, as illustrated in the figures, so that it can be gripped by a conventional spanner.

The external diameter of the cylindrical envelope 20 of the washer 19 is adapted to allow this washer to be movable in rotation in the circular opening 18, as illustrated by an arrow in FIG. 3(b). The effect of rotating the cylindrical envelope 20 about its axis passing through the centre of the opening 18 is to displace the centre of the off-centre orifice 21 on a circle of radius d around the centre of the opening 18 of the tie rod 13. Thus, by modifying the position of the off-centre orifice 21, it is possible to vary the interaxial fastening distance of the tie rod, which corresponds here to the distance between the off-centre opening 21 and the first circular opening 17. More precisely, the interaxial fastening distance may take any value between D−d (angular position of the washer shown in FIG. 3(c)) and D+d (angular position of the washer shown in FIG. 3(b)), according to the angle of rotation imparted to the washer 19. This variable interaxial distance therefore makes it possible to compensate for certain manufacturing tolerances.

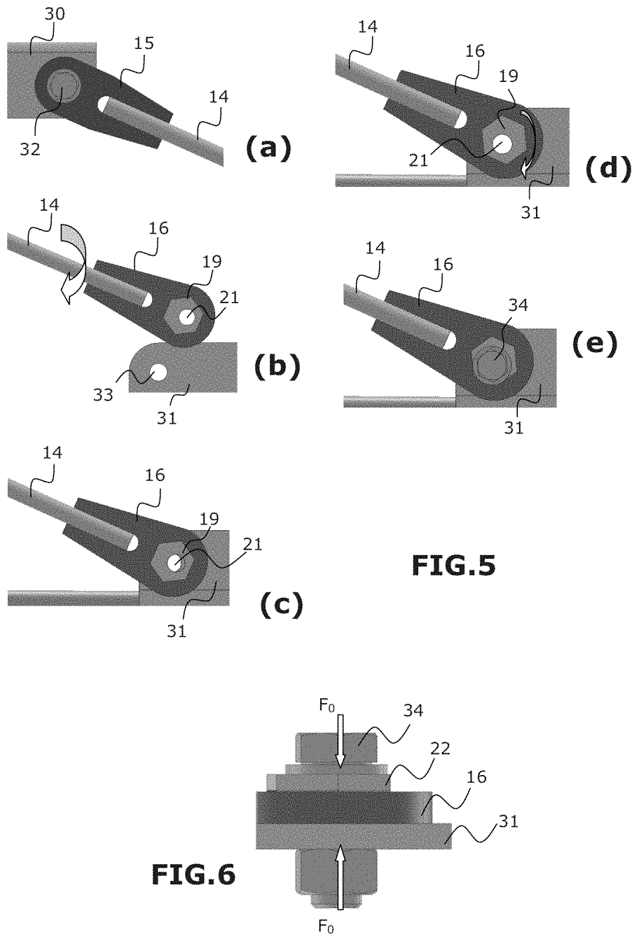

Steps carried out for mounting and fastening the tie rod 13 at two fastening points located respectively on two fastening zones 30 and 31 of a structure will now be described in detail with reference to FIG. 5. The structure in question is, for example, the lattice structure described above with reference to FIG. 2. In this case, the fastening zones 30 and 31 are two zones of two plates 10 which are fastened to the rails 6 and 7.

Each view (a) to (e) of FIG. 5 illustrates a close-up view showing only one of the fastening ends 15 or 16 of the tie rod and the associated fastening zone 30 or 31 of the structure.

The first fastening end 15 of the tie rod is initially fastened with play to a first fastening point on the zone 30 of the structure, as illustrated in view (a) of FIG. 5. This fastening step is conventionally carried out by placing the circular opening 17 (FIG. 3) of the first fastening end 15 next to a corresponding first through-opening (not shown) at the first fastening point. The assembling is then carried out by means of a first fastening screw 32 of a bolt passing through the two adjacent openings. The first fastening screw 32 is temporarily bolted without tightening, so as to allow the tie rod to pivot about the axis of the first fastening screw 32.

Following this, in a positioning step which is schematized by views (b) and (c) of FIG. 5, the tie rod is pivoted about the axis of the first fastening screw 32 until the second fastening end 16 of the tie rod is in front of a second through-opening 33 at the second fastening point, which is located on the fastening zone 31 of the structure. In the position shown in view (c) of FIG. 5, the washer 19 is positioned next to the opening 33 of the structure but the off-centre orifice 21 and the opening 33 are not necessarily concentric. This is because the washer has been introduced in an arbitrary position on the tie rod before mounting, which does not generally match with an interaxial distance corresponding to the distance separating the two fastening points of the structure, which furthermore varies because of the manufacturing tolerances.

In this case, the position of the off-centre orifice 21 is adjusted so that it is positioned correctly in front of the opening 17 of the structure (view (d) of FIG. 5). This adjustment operation is essentially carried out by rotating the washer 19 and slightly pivoting the tie rod about the axis of the first fastening screw 32. Thus, the interaxial distance corresponding exactly to the distance between the openings of the structure may be adjusted, making it possible to compensate for the manufacturing tolerances of the elements of the structure.

A second fastening screw 34 of an assembling bolt is then inserted through the off-centre orifice 21 and the opening 17 of the structure (FIG. 5 (e)).

According to a first mounting possibility, the first fastening screw 32 and the second fastening screw 34 are then tightened firmly in order to obtain a tie rod which is mounted on the structure but without being placed under prestress.

Preferably, however, and according to a second mounting possibility, a torque is applied to the off-centre washer in order to put a slight tension into the tie rod, so as to eliminate all the play in the connections between the plates, the screws and the tie rod. A sufficient tightening torque is then applied in the screw 34 in order to put a tension F₀ into the assembly (see FIG. 6).

This is because if the tie rod is subjected to a tensile force F along its longitudinal body 14, a torque C2 is applied to the washer, the maximum value of this torque being a function of the tensile force F and the distance d, according to the relationship:

C2ₘₐₓ=F×d [Math. 2]

It is thus necessary to oppose this torque C2 in order to ensure that the washer does not turn. In order to do this, the value of the tightening torque C1 must be selected to be greater than the value of the torque C2. In other words, the second fastening screw 34 is tightened with a tightening torque C1 sufficient to oppose rotation of the washer if the tie rod is subjected to a longitudinal tensile force F. The value of the torque C1 is determined by the following relationship:

C1=R₁×F₀×tan φ [Math. 3]

where R₁ is the distance at which the friction force F₀ is applied and tan φ is the coefficient of friction between the materials. The distance R₁, which is represented in FIG. 4(b), advantageously lies between the cylindrical radius R₂₀ of the envelope 20 at the end and the flat of the hexagonal shape 22 of the washer.

The antirotation effect is of course improved by using strips or spikes on the inner bearing surface 23 of the washer 19, and/or by a coating made of a material of the adhesive type.

By virtue of the invention, a single moving part consisting of the off-centre washer makes it possible to fulfil the two functions of taking up play and fastening the tie rod. The solution is thus very simple to implement, with minimal modification of the design of the tie rods hitherto used. The control during the mounting of a tie rod according to the invention on a structure is furthermore very rapid in comparison with known control systems using a screw thread at the end of the tie rod.

1. A tie rod capable of being fastened at two fastening points of a structure by means of two fastening screws, said tie rod comprising:
a longitudinal body provided with a first fastening end comprising a first circular opening, and
a second fastening end comprising a second circular opening,
wherein said tie rod has a washer which comprises a cylindrical external envelope body and is provided with an off-centre through-orifice, said washer being received concentrically in the second circular opening and being movable in rotation in said second circular opening so as to modify the position of the off-centre orifice in order to vary an interaxial fastening distance between said off-centre orifice and the first circular opening.

2. The tie rod according to claim 1, wherein said cylindrical external envelope body is extended by a bearing collar, an inner bearing surface of which is adapted to come to bear against a planar surface of the second fastening end of the tie rod.

3. The tie rod according to claim 2, wherein said bearing collar forms a polygonal head of the washer.

4. The tie rod according to claim 2, wherein the inner bearing surface of said bearing collar has a zone which is structured so as to increase the coefficient of friction of the contact between said inner bearing surface and the planar surface of the second fastening end of the tie rod.

5. The tie rod according to claim 4, wherein said structured zone is formed by spikes protruding in the axial direction of the washer.

6. The tie rod according to claim 4, wherein said structured zone is formed by strips arranged radially around the axis of the washer.

7. The tie rod according to claim 2, wherein the inner bearing surface of said bearing collar has a coating made of a material of the adhesive type so as to increase the coefficient of friction of the contact between said inner bearing surface and the planar surface of the second fastening end of the tie rod.

8. The tie rod according to claim 1, wherein the second circular opening has a diameter greater than the diameter of the first circular opening.

9. The tie rod according to claim 1, wherein the off-centre orifice has a diameter substantially equal to the diameter of the first circular opening.

10. A method for mounting the tie rod according to claim 1 on a structure, wherein said method comprises:
a step of fastening the first fastening end of the tie rod at a first fastening point of the structure, by means of a first fastening screw passing through the first circular opening of the tie rod and a first opening of the structure, which is next to said first circular opening;
a step of positioning the second fastening end of the tie rod substantially next to a second opening, which is located at a second fastening point of the structure, by pivoting the tie rod about the axis of the first fastening screw;
a step of adjusting the position of the off-centre orifice of the washer by rotating the washer in the second circular opening and pivoting the tie rod about the axis of the first fastening screw, in order to position the off-centre orifice in front of the second opening;
a step of fastening the second fastening end of the tie rod to said second fastening point of the structure, by means of a second fastening screw passing through the off-centre orifice of the washer and said second opening.

11. The mounting method according to claim 10, wherein the second fastening screw is tightened with a tightening torque sufficient to oppose rotation of the washer if the tie rod is subjected to a longitudinal tensile force.

12. The mounting method according to claim 11, wherein, prior to the tightening, a torque is applied to the washer in order to put a slight tension into the tie rod.

13. A lattice structure having rails extending mutually parallel along a main extent direction, crossbeams distributed along the main extent direction in order to mechanically connect the rails in pairs, and a plurality of tie rods which connect two adjacent rails and two consecutive crossbeams, said lattice structure being characterized in that at least one tie rod of the plurality of tie rods is a tie rod according to claim 1.

14. A solar tracker comprising:
a mobile device comprising a table equipped with at least one solar energy collection device, a supporting structure extending longitudinally over a length L in order to support said table, a first supporting arch and a second supporting arch, which are configured to support said supporting structure;
a first ground bearing support and a second ground bearing support, which are configured respectively to support the first supporting arch and the second supporting arch; and
a kinematic drive device configured to drive the mobile device in rotation relative to the first ground bearing support and the second ground bearing support;
wherein said supporting structure is a lattice structure according to claim 13.
